(19) United States
(12) Patent Application Publication
(10) Pub. No.: US 2024/0162521 A1
(43) Pub. Date: May 16, 2024

(54) MODULAR THERMAL MANAGEMENT SYSTEMS

(71) Applicant: Caterpillar Inc., Peoria, IL (US)

(72) Inventors: Anthony Wayne Seibert, Lowpoint, IL (US); Anthony Loren De Luca, Germantown Hills, IL (US); Dhanasekar Murugan, Peoria, IL (US); Ramoji Rao Sharma Ravuri, Dunlap, IL (US)

(73) Assignee: Caterpillar Inc., Peoria, IL (US)

(21) Appl. No.: 18/054,807

(22) Filed: Nov. 11, 2022

(51) Int. Cl. H01M 10/63; B60L 50/64; B60L 58/18; B60L 58/26; H01M 10/613; H01M 10/625; H01M 10/6556; H01M 10/6567; H01M 50/204; H01M 50/249; H02J 7/00

(52) U.S. Cl. CPC H01M 10/63; B60L 50/64; B60L 58/18; B60L 58/26; H01M 10/613; H01M 10/625; H01M 10/6556; H01M 10/6567; H01M 50/204; H01M 50/249; H02J 7/0013; H02J 7/0063; B60L 2240/545; H01M 2220/20

(57) ABSTRACT

A modular and on-demand battery thermal management system (BTMS) for an electric machine or a stationary energy storage solution with a battery is disclosed. The BTMS may include one or more independently operable BTMS modules, where each BTMS module may be configured to cool a corresponding component of the electric machine, such as a particular battery pack. Each BTMS module, in turn, may include a plurality of BTMS units that cool coolant that is to be delivered to the components that are to be cooled within the electric machine. The individual BTMS units may be independently operable by a BTMS controller based at least in part on the cooling needs of the components to be cooled. The BTMS controller is also configured to control pumps and valves to appropriately direct coolant to the BTMS units that are operating in a modular fashion.

### TECHNICAL FIELD

The present disclosure relates to a modular thermal management system. More specifically, the present disclosure relates to modular thermal management systems that provide variable levels of cooling of batteries.

### BACKGROUND

Machines, such as mining trucks, loaders, dozers, compaction machines, or other construction or mining equipment, are beginning to be powered by electricity, such as from an on-board electric battery. Machines powered by electricity are used for building, construction, mining and other activities. For example, mining trucks are often used for hauling mined materials from mining sites. It is desirable to power these types of machines using alternative energy, such as electricity that is stored in a battery. Electric machines, for example, may benefit from reduced emissions of carbon (e.g., carbon dioxide), particulates (e.g., diesel soot), nitrogen oxides (e.g., NOx), and/or organic (e.g., volatile organic compounds (VOC)) emissions relative to traditional fuel (e.g., diesel, gasoline, etc.) powered machines.

While electric machinery may provide various improvements, such as environmental advantages, electric machinery may also present new challenges, such as thermal management of the battery or batteries of the electric machine. Batteries of electric machines generally have a thermal operating range that is tighter than other components of the electric machine. For example, the operating temperature range within which a battery may be operated may be about 20° C. or less. For example, an ideal range of battery operating temperatures may be between 10° C. and 30° C. The aforementioned temperature values are merely examples and actual operating temperature values for various batteries may be different from the aforementioned values. Significant excursions outside of acceptable operating temperature ranges of the battery of an electric machine may result in reduced, and sometimes significantly reduced, battery lifetimes, and possibility of failure of the battery. Thus, not controlling the operating temperature of the battery of an electric machine can result in significant cost and/or downtime that manifest in additional cost and/or delays of construction, mining, and/or farming tasks.

Batteries of electric machines further present the challenge of controlling the battery temperature while being operated in a wide variety of operating conditions. For example, when a significant amount of charge is drawn from a battery, such as when the electric machine is used to perform a particularly energy consuming task, the battery may generate significantly more heat than when the electric machine is resting or performing a less energy intensive task. As a result, the cooling needs for operating the battery may be variable, depending on the tasks being performed by the electric machine. Additionally, the battery of an electric machine may need to be cooled while the battery is being charged.

One mechanism for thermal management of a battery is described in U.S. Pat. No. 8,734,975 (hereinafter referred to as “the '975 reference”). The '975 reference describes individual battery cells within each battery module 14 are heated and cooled with liquid coolant from the thermal management system 10. The '975 reference describes that the thermal management system 10 includes a plurality of modular manifold segments 16 which are adapted to connect to each of the cooling channels or heat exchanger fins for each battery cell. However, the systems and methods described in the '975 reference does not pertain to a controlled variable cooling of the battery. Thus, the disclosure of the '975 reference does not describe how to control the temperature of a battery within an operating range while the battery is operated in a wide range of conditions with a highly variable level of thermal output.

Examples of the present disclosure are directed toward overcoming one or more of the deficiencies noted above.

### SUMMARY

In an aspect of the present disclosure, a machine includes a motor to propel the machine, a battery configured to power the motor, a battery controller configured to report a temperature associated with the battery, and a battery thermal management system (BTMS). The BTMS includes a coolant line configured to circulate coolant to cool the battery and a BTMS module having a first BTMS unit and a second BTMS unit, wherein the first BTMS module is configured to provide coolant cooled by the first BTMS unit and the second BTMS unit to cool the battery. The BTMS further includes a BTMS controller configured to receive a temperature level associated with the battery and to independently operate the first BTMS unit and the second BTMS unit.

In another aspect of the present disclosure, a method includes circulating, via a coolant line and using a first pump, coolant from a first battery pack to a first battery thermal management system (BTMS) module configured to cool the coolant, wherein the first BTMS module includes a first BTMS unit and a second BTMS unit. The method further includes determining that the first BTMS unit is to actively operate to cool the first battery pack and causing the first BTMS unit to actively operate. The method still further includes circulating, via the coolant line and using a second pump, the coolant from a second battery pack to a second BTMS module configured to cool the coolant, wherein the second BTMS module includes a third BTMS unit and a fourth BTMS unit, determining that the third BTMS unit is to actively operate to cool the first battery pack, and causing the third BTMS unit to actively operate.

In yet another aspect of the present disclosure, a battery thermal management system (BTMS) includes a first BTMS module configured to cool a first battery pack, the first BTMS module having a first BTMS unit and a second BTMS unit, wherein the first BTMS unit and the second BTMS unit are independently operable, and wherein each of the first BTMS unit and the second BTMS unit are configured to actively or passively cool coolant. The BTMS further includes a second BTMS module configured to cool a second battery pack, the second BTMS module having a third BTMS unit and a fourth BTMS unit, wherein the third BTMS unit and the fourth BTMS unit are independently operable, and wherein the third BTMS unit and the fourth BTMS unit are configured to actively or passively cool the coolant. The BTMS still further includes a BTMS controller configured to receive a temperature level associated with at least one of the first battery pack or the second battery pack and cause at least one of the first BTMS module or the second BTMS module to operate.

### BRIEF DESCRIPTION OF DRAWINGS

FIG. 1 is a schematic illustration of an example electric machine with a battery thermal management system (BTMS), according to examples of the disclosure.

FIG. 2 is a schematic illustration depicting an environment with the battery thermal management system (BTMS) of the electric machine depicted in FIG. 1, according to examples of the disclosure.

FIG. 3 is a schematic illustration depicting an environment with the battery thermal management system (BTMS) units within the BTMS of FIG. 2, according to examples of the disclosure.

FIG. 4 is a schematic illustration depicting an environment with a control system of the battery thermal management system (BTMS) of FIG. 2, according to examples of the disclosure.

FIG. 5 is a flow diagram depicting an example method for providing the battery thermal management system (BTMS) of FIG. 2, according to examples of the disclosure.

FIG. 6 is a flow diagram depicting an example method for operating the battery thermal management system (BTMS) of FIG. 2, according to examples of the disclosure.

### DETAILED DESCRIPTION

Wherever possible, the same reference numbers will be used throughout the drawings to refer to the same or like parts.

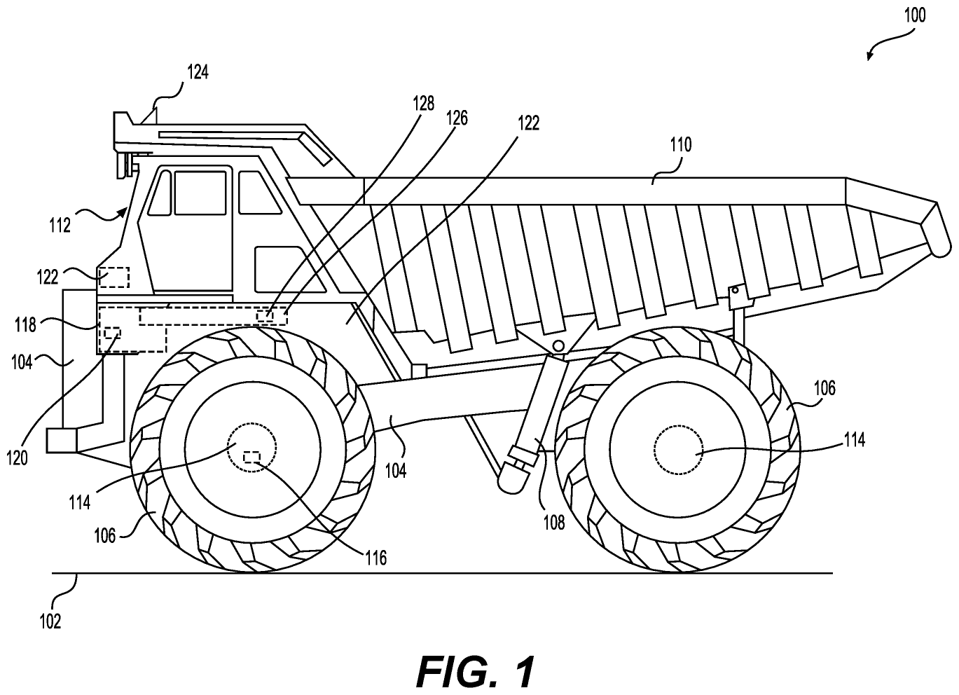

FIG. 1 is a schematic illustration of an example electric machine 100, in accordance with examples of the disclosure. The electric machine 100, although depicted as a mining truck type of machine, may be any suitable machine, such as any type of loader, dozer, dump truck, skid loader, excavator, compaction machine, backhoe, combine, crane, drilling equipment, tank, trencher, tractor, any suitable stationary machine, any variety of generator, locomotive, marine engines, combinations thereof, or the like. The electric machine 100 is configured for propulsion using electricity. However, in some cases the electric machine may also be configured for propulsion using other fuels, in addition to electricity, such as diesel, gasoline, hydrogen and/or hydrogen containing compounds, such as various hydrocarbons (methane, ethane, propane, butane, pentane, hexane, combinations thereof, or the like), compressed natural gas (CNG), natural gas, liquified natural gas (LNG), combinations thereof, or the like. In other words, the systems and methods, as discussed herein, may apply to both electric machines 100, as well as hybrid machines.

The electric machine 100 is illustrated as a mining truck, which is used, for example, for moving mined materials, heavy construction materials, equipment, and/or the like. The electric machine 100 may be used for road construction, building construction, mining, paving and/or other construction applications. For example, the electric machine 100 is used in situations where materials, such as mineral ores, loose stone, gravel, soil, sand, concrete, and/or other materials of a worksite need to be transported over a surface 102 at a worksite. As discussed herein, the electric machine 100 may also be in the form of a dozer, where the electric machine 100 is used to redistribute and/or move material on the surface 102. Further still, the electric machine 100 may be in the form of a compaction machine that can traverse the surface 102 and impart vibrational forces to compact the surface 102. Such a compaction machine includes drums, which may vibrate to impart energy to the surface 102 for compaction. For example, an electric compaction machine is configured to compact freshly deposited asphalt and/or other materials disposed on and/or associated with the surface 102, such as to build a road or parking lot. As yet another example, the electric machine 100 can be in the form of a combine for harvesting grains. It should be understood that the electric machine 100 can be in the form of any other type of suitable construction, mining, farming, military, and/or transportation machine. In the interest of brevity, without individually discussing every type of construction and/or mining machine, it should be understood that the electric drive mechanisms, as described herein, are configured for use in a wide variety of electric powered machine 100.

As shown in FIG. 1, the electric machine 100 includes a frame 104 and wheels 106. The wheels 106 may be mechanically coupled to a drive train (not shown) to propel the electric machine 100. When the wheels 106 of the electric machine 100 are caused to rotate, the electric machine 100 traverses the surface 102. Although illustrated in FIG. 1 as having a hub with a rubber tire, in other examples, the wheels 106 may instead be in the form of drums, chain drives, combinations thereof, or the like.

The electric machine 100 may include a hydraulic system 108 that move a dump box 110 or other moveable elements configured to move, lift, carry, and/or dump materials. The dump box 110 is used, for example, to pick up and carry dirt or mined ore from one location on the surface 102 to another location of the surface 102. The dump box 110 is actuated by the hydraulic system 108, or any other suitable mechanical system. In some cases, the hydraulic system 108 is powered by an electric motor (not shown), such as by powering hydraulic pump(s) (not shown) of the hydraulic system 108. It should be noted that in other types of machines (e.g., machines other than a mining truck) the hydraulic system 108 may be in a different configuration than the one shown herein, may be used to operate elements other than a dump box 110, and/or may be omitted.

With continued reference to FIG. 1, the electric machine 100 may include an operator station 112. The operator station 112 is configured to seat an operator (not shown) therein. The operator seated in the operator station 112 interacts with various control interfaces and/or actuators within the operator station 112 to control movement of various components of the electric machine 100 and/or the overall movement of the electric machine 100 itself.

Thus, control interfaces and/or actuators within the operator station 112 allow the control of the propulsion of the electric machine 100 by controlling operation of one or more motors 114. A motor controller 116 may be controlled according to operator inputs received at the operator station 112. The motors 114 may be powered by a battery system or battery 118, with a battery controller 120. Battery 118, as used herein, may refer to a battery system, batteries (in the plural), or any suitable collection of electrochemical energy storage devices arranged in any suitable manner and with any suitable partitions thereto. The one or more motors 114, in some examples, may be directly coupled to a corresponding wheel 106. In other cases, the one or more motors 114 may be mechanically coupled to the corresponding wheel 106 via one or more mechanical couplers, such as a transmission system (not shown).

The motors 114 may be of any suitable type, such as induction motors, permanent magnet motors, switched reluctance (SR) motors, combinations thereof, or the like. The motors 114 are of any suitable voltage, current, and/or power rating. The motors 114 when operating together are configured to propel the electric machine 100 as needed for tasks that are to be performed by the electric machine 100. The motor controller 116 includes one or more control electronics to control the operation of the motors 114. In some cases, each motor 114 may be controlled by its own motor controller 116. In other cases, all the motors 114 of the electric machine 100 may be controlled by a single motor controller 116. The motor controller 116 may further include one or more inverters or other circuitry to control the energizing of magnetic flux generating elements (e.g., coils) of the motors 114. The motors 114 are mechanically coupled to a variety of drive train components, such as a drive shaft and/or axles or directly to the wheels 106 to rotate the wheels 106 and propel the electric machine 100. The drivetrain may include any variety of other components including, but not limited to a differential, connector(s), constant velocity (CV) joints, etc. Although not shown here, there may be one or more motors 114 that are not used for propulsion of the electric machine 100, but rather to operate pumps and/or other auxiliary components, such as to operate the hydraulic systems 108.

According to examples of the disclosure, the power to energize the motors 114 is received from the battery 118. As discussed herein, the battery 118, as referred to herein, may represent a battery system, a collection of batteries, and/or any suitable hierarchy of a collection of electrolytic cells. As shown, the battery 118 is on-board or carried by the electric machine 100. In some example cases, the motors 114 may operate solely from the power stored in the battery 118. In other example cases, the motors 114 may operate from the battery 118 and/or other off-machine sources of energy, such as an electrified trolley line from which the electric machine 100 can draw power. In yet other example cases, the motors 114 may operate from energy stored in the battery 118, as well as one or more other sources of on-board electrical power, such as a fuel cell. For example, in a fuel cell powered machine, the battery 118 may be used to provide spike power levels, as fuel cells tend to provide a steady level of power that is challenging to increase and/or decrease quickly in response to power needs. According to examples of the disclosure, the battery 118, both individually or along with other sources of power, may provide power for operating the motors 114 and/or other power consuming components (e.g., power electronics, controllers, cooling systems, displays, actuators, sensors, etc.) of the electric machine 100.

The battery 118 may be of any suitable type and capacity. For example, the battery may be a lithium iron phosphate (LiFePO₄ or LFP) battery, lithium-ion battery, a lead-acid battery, an aluminum ion battery, a flow battery, a magnesium ion battery, a potassium ion battery, a sodium ion battery, a metal hydride battery, a nickel metal hydride battery, a cobalt metal hydride battery, a nickel-cadmium battery, a wet cell of any type, a dry cell of any type, a gel battery, combinations thereof, or the like. The battery 118, as discussed herein may be suitable for liquid cooling. The battery 118 may be organized as a collection of electrochemical cells arranged to provide the voltage, current, and/or power requirements of the motors 114. In some cases, the energy capacity of the battery 118 may be sufficient to power the electric machine 100 for several hours or even a whole day. In other cases, the battery 118 capacity may be such that the battery can power the electric machine 100 anywhere from about 30 minutes to about 3 hours. In yet other cases, the battery 118 may only store enough energy to power the electric machine 100 for about 30 minutes or less. It should be understood that the aforementioned values are examples, and the disclosure contemplates battery 118 energy capacity of any suitable value, including ranges outside of the aforementioned ranges.

Regardless of the capacity, type, or whether the battery 118 is the only source of energy for the electric machine 100, the battery 118 may be organized in any suitable way. For example, the battery 118 include any number of cells (not shown), which may be organized in any number of different battery modules (not shown), which may further be organized as battery packs (not shown in FIG. 1). For example, there may be a single battery pack for the battery 118. In other cases, the battery 118 may include two separate battery packs. In yet other cases, there may be three, four, or indeed, any suitable number of battery packs or other partitions within the battery 118. Although this disclosure uses the term “pack,” it should be understood that the disclosure contemplates other terms for sections of batteries, such as sections that include a collection of cells. Some of these other portions of the battery 118 may be groups, packs, sections, modules, or the like. In other cases, the battery 118 may actually be a battery system with multiple batteries therein. Again, with respect to this disclosure, partitions (e.g., battery packs) of a battery 118 or battery system may be independently temperature controlled.

The battery controller 120 may be configured to allow the battery 118 to provide power to various components of the electric machine, such as the motors 114, electronics, controllers, etc. of the electric machine 100. The battery controller 120 may also be configured to provide a variety of information, such as to other controllers of the electric machine 100 pertaining to the battery 118. In some examples, the battery controller 120 may be configured to provide individual information about individual modules, cells, or other segments or partitions of the battery 118. In some cases, the battery controller 120 may periodically send data about the battery 118 to another controller or other entity. In the same or other cases, the battery controller 120 may send data about the battery when requested to do so, such as by another controller of the electric machine 100.

The battery controller 120 may, in examples, determine information about the battery 118 from any suitable source, such as any variety of sensors, such as a temperature sensor. For example, the battery 118 may have associated temperature sensors (not shown) that can provide temperatures for individual modules and/or cells of the battery 118 to the battery controller 120. The battery controller 120 may receive signals from any variety of these sensors associated with the battery and determine physical measurements therefrom. For example, the battery controller 120 may receive a signal from a thermocouple of a battery cell and determine the associated temperature of that battery cell from the received signal from the thermocouple. In addition to temperature of cells within the battery 118, the battery controller 120 may be configured to receive sensor signals associated with cooling fluids (e.g., coolant) used to cool the battery 118. For example, the battery controller 120 may be configured to determine the coolant inlet temperature, the coolant outlet temperature, the coolant inlet pressure, and/or the coolant outlet pressure of any coolant used to cool the battery 118 during operation and/or charging.

The electric machine 100 includes an electronic control module (ECM) 122 that controls various aspects of the electric machine 100. The ECM 122 is configured to receive battery status (e.g., state-of-charge (SOC) or other charge related metrics) from the battery controller 120, operator signal(s), such as an accelerator signal, based at least in part on the operator's interactions with one or more control interfaces and/or actuators of the electric machine 100. In other cases, the ECM 122 may receive control signals from a remote control system by wireless signals, received via an antenna 124. The ECM 122 uses the operator signal(s), regardless of whether they are received from an operator in the operator station 112 or from a remote controller, to generate command signals to control various components of the electric machine 100. For example, the ECM 122 may control the motors 114 via the motor controller 116, the hydraulic system 108, and/or steering of the electric machine 100 using respective controllers (not shown). It should be understood that the ECM 122 may control any variety of other subsystems of the electric machine 100 that are not explicitly discussed here to provide the electric machine 100 with the operational capability discussed herein.

The ECM 122 may include single or multiple microprocessors, field programmable gate arrays (FPGAs), digital signal processors (DSPs), and/or other components configured to control the electric machine 100. Numerous commercially available microprocessors can be configured to perform the functions of the ECM 122. Various known circuits are operably connected to and/or otherwise associated with the ECM 122 and/or the other circuitry of the electric machine 100. Such circuits and/or circuit components may include power supply circuitry, inverter circuitry, signal-conditioning circuitry, actuator driver circuitry, etc. The present disclosure, in any manner, is not restricted to the type of ECM 122 or the positioning depicted of the ECM 122 and/or the other components relative to the electric machine 100. The ECM 122 is configured to control the use of energy from the battery 118 and may cooperate with other controllers of the electric machine 100 in a manner that enhances the range or performance of the electric machine 100. In some cases, the ECM 122 may also provide the control functions for cooling the battery 118 that is discussed herein.

The electric machine 100 further includes a battery thermal management system (BTMS) 126. The BTMS 126 is configured to provide coolant to the battery 118 to maintain the temperature of the battery 118 and/or portions thereof within an acceptable operating range. The operating range of the battery 118 to which temperature may be controlled by the BTMS 126 may be a range that provides for reduced chances of failure of the battery 118 and/or greater chances of long-term longevity of the battery 118. Overheating of batteries 118, particularly of the type of batteries 118 used on the electric machine 100 may result in failure (e.g., explosion, leak, etc.) of the battery and/or a reduced overall lifetime of the battery 118. For example, high operating temperatures of the battery 118 may lead to accelerated degradation of the electrolytes and/or the electrodes of the battery 118. To prevent battery failure and to enhance the operating lifetime of the battery 118, the BTMS is used to control the operating temperature of the battery, according to the disclosure herein. It should also be noted that although the BTMS 126 is discussed in the context of thermal management of the battery 118, the BTMS may also be used for thermal management of any suitable component of the electric machine, such as power electronics, controllers, hydraulic components, etc.

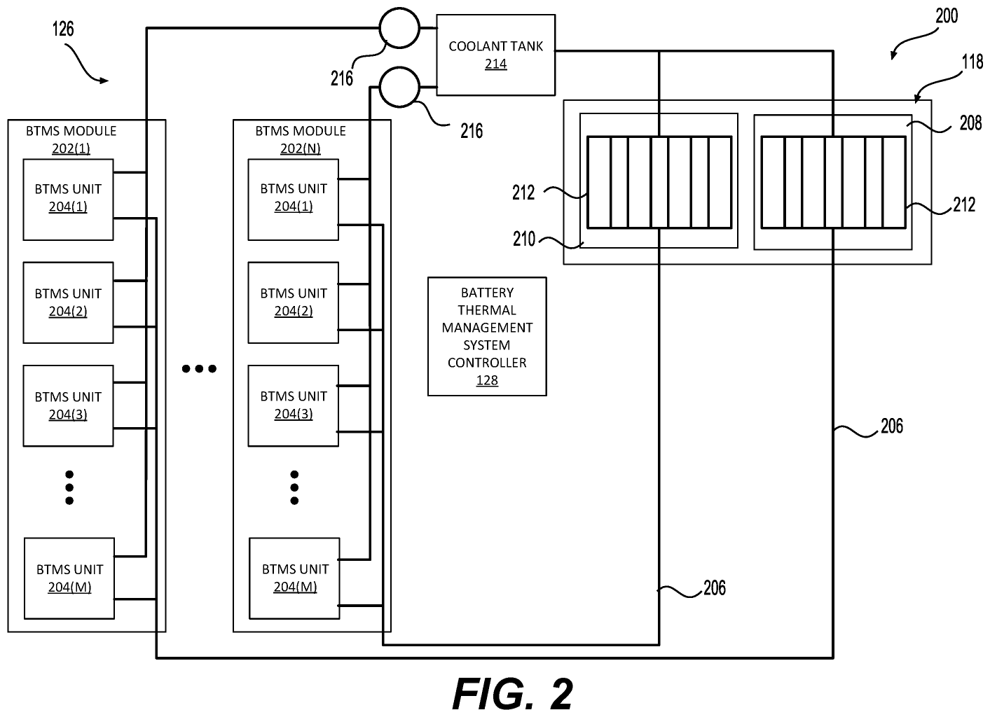

The BTMS 126 may include a BTMS controller 128 that provides control functions for modular and controllable cooling of the battery 118, depending on the thermal needs of the battery 118. The BTMS 126 has selectable levels of cooling, as will be discussed in greater detail in conjunction with FIG. 2. The BTMS controller 128 is configured to receive temperature or other operating information from one or more other entities, such as the battery controller 120, and determine the cooling needs of the BTMS 126 therefrom. For example, the BTMS controller 128 may receive a particular maximum cell temperature level of a particular module of the battery 118. The BTMS controller 128 may then operate a portion of the BTMS 126 at a level commensurate with the cooling needs of the battery pack, as determined from the received indication of the maximum cell temperature. The BTMS 126 may be modular and provides variable levels of cooling power, as instructed by the BTMS controller 128. In this way, the battery 118 is not cooled too much or too little, resulting in a dynamic cooling control to relatively tight ranges. It should be noted that in alternative examples, the functions of the BTMS controller 128, as disclosed herein, may be performed by other controllers of the electric machine, such as the ECM 122.

The electric machine 100 further includes any number of other components within the operator station 112 and/or at one or more other locations on the frame 104. These components include, for example, one or more of a location sensor (e.g., global positioning system (GPS)), an air conditioning system, a heating system, communications systems (e.g., radio, Wi-Fi connections), collision avoidance systems, sensors, cameras, etc. These systems are powered by any suitable mechanism, such as by using a direct current (DC) power supply powered by the battery 118 and/or any other source. The BTMS 126, as disclosed herein, may be used to control the temperature of any of the aforementioned components of the electric machine 100.

It should be understood that the electric machine 100 as discussed herein, provides for an improved modular BTMS 126 that can provide variable levels of cooling to any number of modules of the battery 118. The thermal management of the battery 118 using the BTMS 126 may be performed while the electric machine 100 is operational, is idling, is turned off, and/or when the battery 118 is being charged. The BTMS controller 128 may receive a variety of information about the battery 118 and/or modules thereof, such as from a battery controller 120, and control the temperature of the battery 118 and/or module thereof within a desired operating range. The BTMS controller 128 may engage multiple units of the BTMS 126, as needed to control the temperature of the battery 118 within the desired range of temperatures. As discussed herein, good control of the operating temperature of the battery 118 may result in greater longevity of the battery 118, as well as reduced chances for failure of the battery 118.

Although the BTMS 126 is discussed herein as part of the electric machine 100, it should be understood that the electric machine 100 is only one application for the BTMS 126. The BTMS 126, as disclosed herein, may be used for any suitable energy storage solution, both mobile and stationary. For example, the BTMS 126, as disclosed herein, may be deployed for stationary energy storage and bidirectional power grids. Furthermore, the BTMS 126 may be used for other mobile solutions other than the electric machine 100.

FIG. 2 is a schematic illustration depicting an environment 200 with a battery thermal management system (BTMS) 126 of the electric machine 100 depicted in FIG. 1, according to examples of the disclosure. The BTMS 126 may be organized in one or more BTMS modules 202(1), . . . 202(N), hereinafter referred to individually as BTMS module 202 or in plurality as BTMS modules 202. Each of the BTMS modules may include a plurality of BTMS units 204(1), 204 (2), 204(3), . . . 204(M), hereinafter referred to individually as BTMS unit 204 or in plurality as BTMS units 204. The BTMS units 204 may be fluidically connected to coolant lines 206 that conduct coolant therein.

The BTMS 126 may be used to control the temperature of the battery 118. The battery 118 is depicted as having two battery packs 208, 210. In other cases, the battery 118 may have any number of different packs. In some examples, each BTMS module 202 may correspond to a battery pack 208, 210. In other words, each BTMS module 202 may be dedicated to cooling a corresponding respective battery pack 208, 210. In other cases, more than one BTMS module 202 may be used to cool a single battery pack 208, 210. In still other cases, one BTMS module 202 may be used to cool more than one battery pack 208, 210.

Each battery pack 208, 210 may be partitions of the battery 118. The battery packs 208, 210 may include a plurality of cells of the battery 118. In some cases, all of the battery packs 208, 210 of a particular battery 118 may be of the same size (e.g., contain the same number of constituent cells, supply substantially the same voltage, current, power, etc.). In other cases, the battery packs 208, 210 of the battery 118 may be of different sizes. Further, in some cases, each of the battery packs 208, 210 may have their own battery controller 120. In other cases, the battery 118 may have a single battery controller 120 that provide control, measurement, and reporting/communications functions for all of the battery packs 208, 210 of the battery 118. Although not shown here, the battery packs 208, 210 may include any number of sensors, such as temperature sensors (e.g., thermocouples). In some cases, the sensors may indicate, to the battery controller 120, the temperature of individual cells of the battery 118.

The battery controller 120 may be configured to determine the temperature of cells within the battery 118. For example, the battery controller 120 may be configured to determine the temperature of cells within each of the battery packs 208, 210. Again, it should be noted that even though two battery packs 208, 210 are shown here, in other examples, there may be any number of different battery packs 208, 210, and the battery controller 120 may be configured to determine the temperature associated with any number of battery packs 208, 210. Additionally, the battery controller 120 may determine temperature statistics associated with individual battery packs 208, 210 and report the temperature statistics to the battery thermal management system (BTMS) controller 128.

As an example, the battery controller 120 may receive a number of cell temperatures associated with battery pack 208 and determine the highest temperature and the lowest temperature of the cells (e.g., the range of cell temperatures) and report those high and low cell temperatures to the BTMS controller 128. The BTMS controller 128 may then determine the cooling needs of the battery pack 208, based at least in part on the high and low cell temperatures, as received from the battery controller 120. It should be appreciated that the cooling needs of the battery packs 208, 210 may be determined based at least in part on other temperature measurements associated with the battery packs 208, 210. The BTMS controller 128 may further operate the BTMS module 202(1) corresponding to the battery pack 208 in a manner such that the BTMS module 202(1) provides the cooling needs of the battery pack 208. In some cases, the BTMS controller 128 may determine how many and/or which ones of the BTMS units 204 to actively operate within the BTMS module 202(1) to provide the cooling needs of the battery pack 208. A similar procedure may be performed by the battery controller 120 and/or the BTMS controller 128 for the battery module 210 and the corresponding BTMS module 202(N).

When the BTMS modules 202 are operated, such as by actively or passively operating one, some, or all of the BTMS units 204 within that BTMS module 202, coolant may be delivered through the coolant lines 206 to heat exchangers 212 proximal to the battery packs 208, 210, to cool the respective battery pack 208, 210. After the coolant flows through one or more heat exchangers 212, the coolant may be conducted by the coolant lines 206 to a coolant tank 214. The coolant tank 214 may serve as a coolant reservoir, or a sump tank, from which coolant may be pumped according to the needs of the BTMS 126, as determined by the temperature of the battery 118 and/or its battery packs 208, 210. Coolant pumps 216 may be configured to pump coolant to and/or through the BTMS modules 202 and/or individual BTMS units 204. The BTMS controller 128 may also control the operation of the coolant pumps 216 to provide a correct amount of coolant flow through the BTMS modules 202, BTMS units 204, and/or the heat exchangers 212.

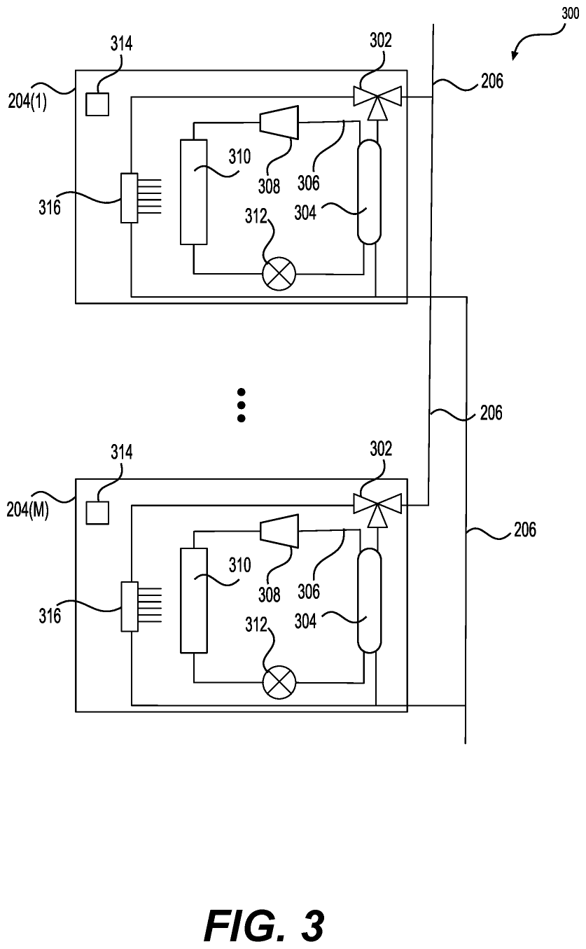

As shown, the BTMS modules 202 may be disposed in a parallel manner, where each BTMS module 202 has its own coolant inlet and outlet. In other words, the coolant flow in one BTMS module 202 may not have an effect on the coolant flow through another BTMS module 202. Within each BTMS module 202 the BTMS units 204 may be arranged in parallel. In other words, when multiple BTMS units 204 within a BTMS module 202 are turned on or actively cooling coolant, coolant may flow through all of the BTMS units 204 of the BTMS module 202. Each of the BTMS units 204 of the BTMS module 202 may operate in an active mode or in a passive mode. When operating in an active mode, the BTMS unit 204 may cool the coolant passing therethrough in an active manner. When operating in a passive mode, the coolant may pass through a radiator or other heatsink of the BTMS unit 204. Whether individual BTMS units are to operate in an active or passive mode may be determined by the BTMS controller 128 and based at least in part on temperature data associated with the battery 118 and/or the battery packs 208, 210. In some cases, whether individual BTMS units are to operate in an active or passive mode may further be determined based at least in part on ambient conditions, as received by the BTMS controller from the ECM 122 or other controller. The operation of individual BTMS units 204 is discussed in greater detail in conjunction with FIG. 3.

The coolant pumps 216 may be operated, such as by the BTMS controller 128, to pump a sufficient amount of coolant through each of the BTMS modules 202. Although depicted as each BTMS module 202 having its own coolant pump 216, it should be appreciated that, alternatively, multiple BTMS modules 202 may share a coolant pump 216 or multiple coolant pumps 216 may pump coolant through a single BTMS module 202. Although shown here as being disposed upstream of the BTMS modules 202, the coolant pumps may, alternatively and/or additionally be disposed downstream of the BTMS modules 202 and/or even within the BTMS modules 202.

The BTMS controller 128 may be configured to control the coolant pumps 216 according to the cooling needs of the battery packs 208, 210 and/or the cooling levels of the respective BTMS modules 202. For example, the coolant pumps 216 may be operated to pump additional coolant, such as from the coolant tank 214, based at least in part on the cooling needs to the corresponding battery pack 208, 210. In some cases, there may be a certain level of coolant flow for each BTMS unit 204 that is operated (e.g., in active mode). In other words, the BTMS controller 128 may instruct the coolant pump 216 to increase coolant flow by a certain quantum for each BTMS unit 204 of the BTMS module 202 that is active.

As shown in FIG. 2, it should be noted that each of the battery packs 208, 210 can be independently cooled, with its own dedicated BTMS module 202. This allows for better and more robust control of temperature for the different battery packs 208, 210 of the battery 118 than conventional cooling systems. Additionally, within a BTMS module 202 there are variable selectable levels of cooling possible by selecting the number of BTMS units 204 to operate actively within the BTMS module 202. By activating the BTMS units 204 of a BTMS module 202 according to the cooling needs of the corresponding battery pack 208, 210, the operating temperature of the battery 118 can be tightly controlled, resulting in more efficient operation of the battery 118 and greater longevity of the battery 118.

FIG. 3 is a schematic illustration depicting an environment 300 with the battery thermal management system (BTMS) units 204 within the BTMS 126 of FIG. 2, according to examples of the disclosure. As shown, two specific BTMS units 204(1), 204(M) within a particular BTMS module 202 is depicted, along with example constituent components of the BTMS units 204(1), 204(M). Although two particular BTMS units 204(1), 204(M) are shown, there may be any number of BTMS units 204 within this BTMS module 202, as indicated by the ellipses between BTMS units 204(1), 204(M).

As discussed herein, the BTMS units 204 of a BTMS module 202 may be operated independently or in conjunction with the other BTMS units 204 of the BTMS module 202. Individual BTMS modules may be operated in either an active mode (e.g., with a refrigeration operation) or a passive mode (e.g., with flow through a radiative element). In some cases, all of the BTMS units 204 within a particular BTMS module 202 may be substantially identical, such as with a similar or same model number, manufacturer, type, capacity, combinations thereof, or the like. In other cases, different BTMS units 204, such as different type and/or model, may be provided within a BTMS module 202.

The BTMS units 204 may be of any suitable type that can provide cooling of a fluidic coolant within the coolant lines 206. For example, the BTMS units 204 may be or include any suitable refrigeration system, such as any proprietary refrigeration system and/or any suitable commercially available refrigeration system.

The coolant flow within each of the BTMS units 204 may be controlled by one or more valves 302. For example, as shown, valve 302 may be disposed such that the coolant may selectively flow into a chiller 304. The BTMS unit 204 may further include a refrigerant line 306, a compressor 308, a condenser 310, an expansion valve 312, a BTMS unit controller 314, and a radiator 316. Refrigerant may flow through the refrigerant line 306, as well as the chiller 304, the compressor 308, the condenser 310, and the expansion valve 312 when the BTMS unit 204 is operated in an active mode. When the BTMS unit 204 is operated in a passive mode, the refrigerant may not flow through the aforementioned elements. Rather, in passive mode, coolant may be flowed through the radiator 316. It should be understood that although a particular refrigeration unit is discussed with respect to the BTMS units 204, the disclosure herein contemplates using any suitable type or refrigeration system for the BTMS units 204.

The valve 302, such as in the form of a three-way valve, in some examples, may be controlled by the BTMS controller 128 or any other suitable control system. In alternate examples, the BTMS unit controller 314 may control the valves 302 to allow coolant to flow into either the chiller 304, when that unit is in active mode, or the radiator 316, when that unit is in passive mode. In other cases, other controllers may control the valve 302 and, thereby, the flow of coolant within individual ones of the BTMS units 204. Regardless of which entity controls the valve 302, coolant may be allowed to flow within a particular BTMS unit 204 through chiller 304 or for a predetermined period of time after that BTMS unit 204 is to be operated in passive mode. For example, coolant may flow through the chiller 304 even after the refrigerant is not compressed in the compressor 308, if the refrigerant is still cool and can extract thermal energy from the coolant in the coolant lines 206.

The refrigerant, as flows through refrigerant line 306 may be of any suitable type, such as R-410A, R-407C, R-134a, R22, freon, any variety of hydrofluorocarbons, any variety of chlorofluorocarbons, or indeed any compressible gas or liquid. The BTMS units 204, when turned on or in active mode, may operate similarly as commercial refrigeration systems, where the refrigerant is compressed by the compressor 308, undergoes state change in the condenser 310, and flow regulated by the expansion valve 312. At the chiller 304, which may also be referred to as an evaporator, thermal energy from the coolant is transferred, in part, to the refrigerant. In other words, the coolant is cooled down at the chiller 304. The coolant may include any suitable fluid, such as water, glycol, oil, surfactant, air, combinations thereof, or the like. The BTMS unit controller 314 for each of the BTMS units 204 may control its own BTMS unit 204, and optionally the valve 302. In other words, the BTMS unit controller 314, based at least in part on instructions received from the BTMS controller 128, may control the operations of the chiller 304, the compressor 308, the condenser 310, the expansion valve 312, and/or any other elements of its BTMS unit 204.

According to examples of the disclosure, the BTMS controller 128 is configured to selectively turn on and turn off (e.g., operate in an active mode or a passive mode) individual BTMS units 204 within a BTMS module 202. The BTMS controller 128 may also track the active use time of each of the BTMS units 204 within each of the BTMS modules 202. The BTMS controller 128 may still further keep track of the last time when any BTMS unit 204 under its control was operated actively. The BTMS controller 128 may be configured to use data, such as temperature data from the battery 118 and/or its constituent packs 208, 210, along with active usage data of each of the individual BTMS units 204 to determine which, if any of the BTMS units are to be operated in active mode to regulate the temperature of the battery 118 and/or its constituent battery packs 208, 210.

When the BTMS unit 204 is operated in a passive mode, the coolant may be flowed through radiator 316, such as by controlling the valve 302. When operating in the passive mode, the active, energy consuming portions of the BTMS unit 204 (e.g., compressor 308, condenser 310, etc.) do not need to be operated. Rather the coolant may shed thermal energy in the radiator 316. When the temperature of the battery 118 and/or battery packs 208, 210 are within a desired range, the BTMS units 204 of the corresponding BTMS module 202 may be operated in the passive mode.

It should be appreciated that by independently controlling individual BTMS units 204 within a BTMS module 202, the BTMS controller 128 is able to control the level of cooling. Cooling, as used herein refers to one or both of extracting thermal energy from an element being cooled, such as the battery 118, its constituent battery packs 208, 210, power electronics, hydraulic systems, or the like, or to reducing the temperature of the element being cooled. Thus, depending on the cooling needs of the battery 118 or power electronics of the electric machine 100, the BTMS 126 can be operated in a manner to provide the appropriate level of cooling to the appropriate components of the electric machine 100. As a result, the BTMS 126 can be operated in a modular way to dynamically respond to the cooling needs of components, such as the battery 118, of the electric machine 100.

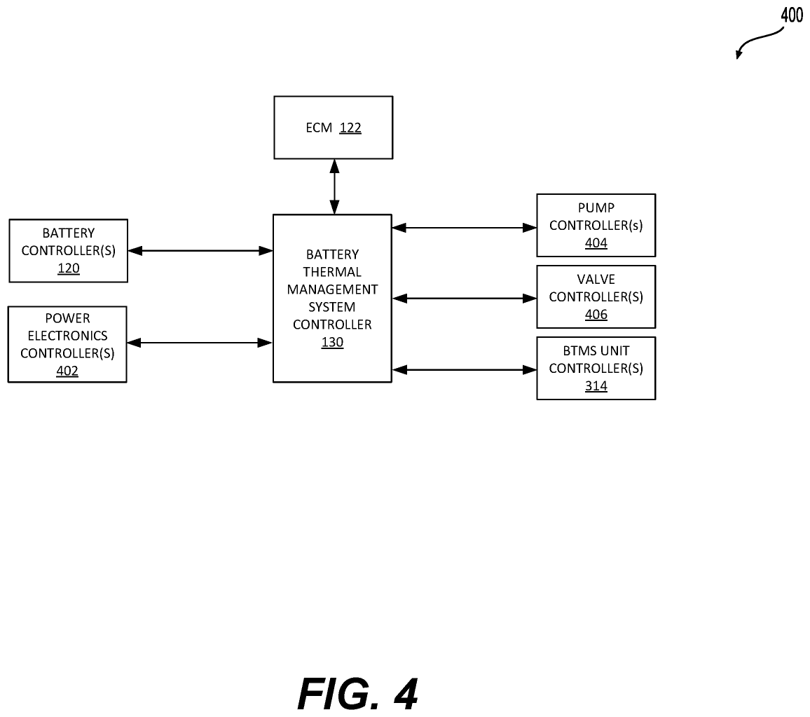

FIG. 4 is a schematic illustration depicting an environment 400 with a control system of the battery thermal management system (BTMS) of FIG. 2, according to examples of the disclosure. As discussed herein, the BTMS controller 128 may receive a variety of signals that it processes to enable that the BTMS 126 to operate in a manner to keep the temperature of the battery 118 and/or individual battery packs 208, 210 within a controlled range of temperatures.

As discussed herein, the BTMS controller 128 may receive signals from the battery controller 120 that indicates parameters, such as the temperature of the battery 118 and/or individual battery packs 208, 210 of the battery 118. As discussed herein, in some cases, only one battery controller 120 may report parameters of the battery 118 or even more than one battery to the BTMS controller 128. In other cases, there may be multiple battery controllers 120, such as a dedicated battery controller 120 for each of the battery packs 208, 210, that report battery 118 related or battery pack 208, 210 related parameters to the BTMS controller 128. The parameters that are reported may be any suitable battery 118 or battery pack 208, 210 related parameters, such as temperatures of individual cells of the battery 118 and/or battery packs 208, 210, high and/or low temperatures of cells of the battery 118 and/or battery packs 208, 210, other statistics (e.g., mean median, standard deviation, etc.) of temperatures of cells of the battery 118 and/or battery packs 208, 210, or the like. The battery controller 120, or any other suitable controller, may also be configured, in some cases, to determine and report to the BTMS controller 128 one or more parameters of the coolant used to cool the battery 118 and/or its battery packs 208, 210, such as inlet pressure, outlet pressure, inlet temperature, outlet temperature, etc.

The BTMS controller 128 may further be configured to receive signals from a power electronics controller 402 providing parameters associated with power electronics of the electric machine 100. As discussed herein, the BTMS 126 may also be used to cool power electronics, or indeed any other component of the electric machine 100 to is to be operated within a controlled temperature range. Similar to the battery controller 120, the power electronics controller 402 may provide any variety of information to the BTMS controller 128, such as temperature(s) or statistical aggregations thereof of the power electronics and/or any variety of temperature and/or pressure data associated with the coolant used to cool the power electronics.

The BTMS controller 128 may still further be configured to receive ambient condition (e.g., ambient temperature, ambient pressure, etc.) information from the ECM 122 or other controller. This ambient information may also, in some examples, be used to determine whether individual BTMS units 204 of a particular BTMS module 202 are to be operated in an active or passive mode.

The BTMS controller 128 may receive information (e.g., parametric data) from one or both of the battery controllers 120 and/or the power electronics controllers 402 and determine if a BTMS unit 204 in one or more BTMS modules 202 are to be operated in an active mode. In some cases, the determination of whether a BTMS unit 204 is to be operated in an active mode may be determined based at least in part on ambient conditions, as received by the BTMS controller 128 from the ECM 122 or other controller. As discussed in conjunction with FIG. 3, in some cases, individual BTMS modules 202 may correspond to respective individual battery packs 208, 210. Thus, if a particular battery pack 208, 210 is to be cooled due to high temperature of that battery pack 208, 210, as determined from signal(s) received from the battery controller(s) 120, then the BTMS controller 128 may cause at least one BTMS unit 204 within the corresponding BTMS module 202 to be operated in an active mode. It will be appreciated that the BTMS controller 128 may command the active operation, or alternatively passive operation, of a single BTMS module 202, some BTMS modules 202, or all of the BTMS modules 202 available on the electric machine 100 depending on the cooling needs of the battery 118 and/or other components of the electric machine 100.

When it is determined, by the BTMS controller 128, that a particular BTMS module 202 is to be actively operated, the BTMS controller 128 may further determine how many and/or which of the constituent BTMS units 204 are to be actively operated within that BTMS module 202. It should be understood that the BTMS controller 128 may make this determination concurrently, or in an interleaved manner, for all of the BTMS modules 202 that are to be operated on the electric machine 100. Based at least in part on the determination of which BTMS units 204 with each of the BTMS modules 202 to be operated in an active mode, the BTMS controller 128 may generate and send commands to various controllers of the electric machine 100. For example, the BTMS controller 128 may determine command(s) to operate the pumps 216 and send those pump command(s) to one or more pump controller(s) 404 configured to operate the pumps 216. Similarly, the BTMS controller 128 may determine command(s) to operate the valve(s) 302 and send those valve command(s) to one or more valve controller(s) 406 configured to operate the valve(s) 302. Note that in some cases, the valves 302 may be controlled by the BTMS controller 314. Furthermore, the BTMS controller 128 may determine command(s) to control individual BTMS unit(s) 204 and send those BTMS unit command(s) to the corresponding BTMS unit controller(s) 314. It should be understood that there may be other components and/or other controllers that may be instructed by the BTMS controller 128 in operating the BTMS 126 in the dynamic and modular mechanism, as disclosed herein.

In some implementations, the BTMS controller 128, as well as any of the other controllers discussed herein, may include an electronic control module, a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, BTMS controller 128 may possess its own local memory, which also may store program modules, program data, and/or one or more operating systems. For example, the memory/storage may store battery thermal management control software to enable the methods disclosed herein. The BTMS controller 128 may include one or more cores.

In some instances, the communications between the BTMS controller 128 and the various other components and/or controllers of the electric machines 100 may be via any suitable protocol-based communications or any suitable non-protocol-based communications. In examples of the disclosure, the BTMS controller 128 may have wired communicative connections with the various components of the electric machine 100 with which it communicates. In other cases, the BTMS controller 128 may have wireless communicative connections (e.g., Bluetooth, WiFi, Direct WiFi, etc.) with the various components of the electric machine 100 with which it communicates. In yet other cases, the BTMS controller 128 may have a mix of wired and wireless communicative links with the various components of the electric machine 100 with which it communicates. Regardless of the exact nature of its communicative links, the BTMS controller 128 is configured to receive various information about the components (e.g., battery packs 208, 210) that it is to cool and determine based upon that information and any other data, which if any of the BTMS modules 202 and constituent BTMS units 204 to operate.

In further examples, the BTMS controller 128 is configured to track the usage of each of the BTMS units 204 in active mode. The BTMS controller 128 may determine which BTMS units 204 to actively operate within individual BTMS modules 202 based at least in part on the total active operating time of the various BTMS units 204. For example, when BTMS units 204 within a BTMS module 202 are to be actively operated, the BTMS controller 128 may cause those BTMS units 204 with the least active operating time to be operated. This may improve the overall longevity of the BTMS 126 and/or the constituent BTMS modules 202 and/or the BTMS units 204.

In some cases, the BTMS controller 128 is configured to track when each of the BTMS units 204 as disposed within any of the BTMS modules 202 of the BTMS 126 was last used in active mode. The BTMS controller 128, in some examples, may operate BTMS units 204 based at least in part on when a particular BTMS unit 204 was last operated in active mode. BTMS units 204 may have a latency period, during which it is not efficient, or otherwise desirable, to actively operate the BTMS unit 204. Therefore, in some cases, the BTMS controller 128, when an additional BTMS unit 204 is required to actively operate, may select a BTMS unit 204 that has not been actively operated recently. In other words, the BTMS controller 128 may not instruct the operation of any BTMS units 204 that are within the latency period after its last active use. In some cases, the latency period may be a time period in the range of about 15 seconds to about 6 minutes. For example, in some cases, the latency period may be about 2 minutes from a BTMS unit's last active use. The preceding range is just an example, and it will be understood that the latency period of the BTMS units 204 may be of any suitable value.

It will be understood that the control mechanism, as depicted in the environment 400, may allow a modular and on-demand operation of the BTMS 126. Only BTMS modules 202 corresponding to elements that are to be cooled may be operated. Furthermore, only the BTMS units 204 within the operating BTMS module 202 are actively operated. In this way, cooling is provided only where it is needed and not for components that do not need to be cooled. Additionally, the cooling level is modulated according to cooling needs. This provides for better control of cooling needs in a robust and dynamic way.

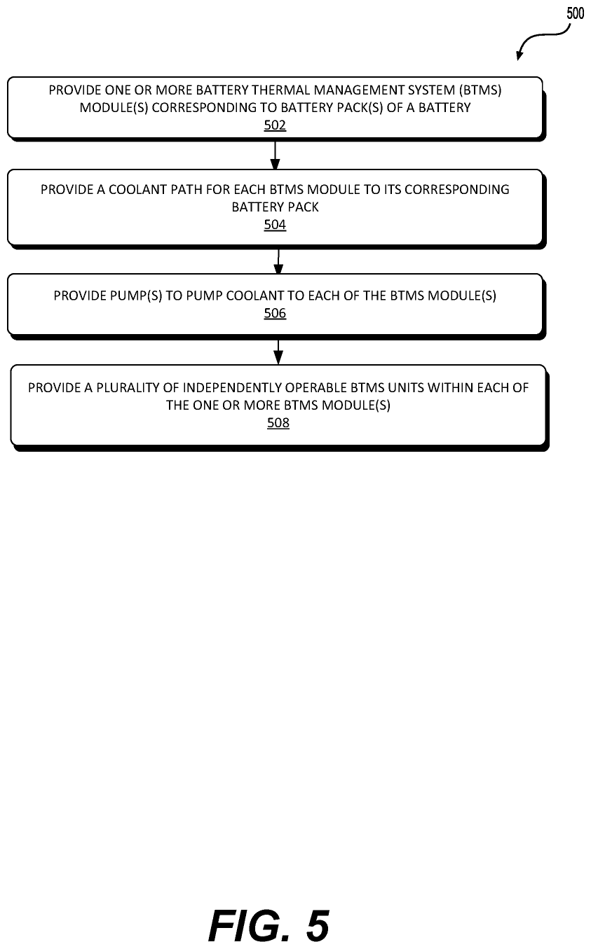

FIG. 5 is a flow diagram depicting an example method 500 for providing the battery thermal management system (BTMS) 126 of FIG. 2, according to examples of the disclosure. The processes of method 500 may be performed by any suitable manufacturer of BTMS 126, system integrators, manufacturers of electric machines 100, other third party original equipment manufacturers (OEMs), combinations thereof, or the like.

At block 502, one or more battery thermal management system (BTMS) module(s) 202 are provided, where each of the BTMS modules 202 correspond to battery packs 208, 210 of a battery 118. As discussed herein, the BTMS modules 202 of the BTMS 126 may be independently operable. For example, a particular BTMS module 202 may be operated when its corresponding element to be cooled (e.g., battery pack 208, 210, power electronics, etc.) are to be cooled. As further discussed herein, the individual BTMS modules 202 are independently operable, such as by control of the BTMS controller 128. The BTMS modules 202 may be operated based at least in part on measurements (e.g., temperature measurements, etc.) of the element to be cooled by each of the BTMS modules 202.

At block 504, a coolant path is provided for each BTMS module 202 to its corresponding battery pack 208, 210. The coolant path may be the coolant lines 206, as discussed herein. The coolant path may also include the heat exchangers 212, as discussed herein. In general, the coolant path may include any suitable element through which the coolant may flow, such as in a cycle where the coolant is cooled at the BTMS module 202 and then used to cool the battery pack 208, 210 or other element to be cooled. The coolant lines 206 and/or heat exchangers may be constructed of any suitable material, such as stainless steel, steel, aluminum, polytetrafluoroethylene (PTFE), or any other suitable material.

At block 506, one or more pump(s) 216 may be provided to pump coolant to each of the BTMS module(s) 202. In some cases, there may be provided a single pump 216 for each BTMS module 202. In other cases, there may be provided more than one pump 216 for each of the BTMS modules 202. In yet other cases two or more BTMS modules may share a single pump 216. Regardless of the pump 216 to BTMS module 202 configuration, the pump(s) 216 may be controlled, such as by the BTMS controller 128 in conjunction with a local controller, to pump coolant through the coolant lines 206 to the BTMS modules 202. In some cases, the pump 216 may be upstream of its corresponding BTMS module 202. In other cases, the pump 216 may be downstream of its corresponding BTMS module 202. In either case, pumping of coolant within the coolant line 206 provides for the coolant to pass through the respective BTMS module 202 and/or any operational BTMS units 204 within the BTMS module 202. In some cases, the pump(s) 216 may be configured to pump coolant that is stored in the coolant tank 214, which may serve as a coolant reservoir or sump tank.

At block 508, a plurality of independently operable BTMS units 204 may be provided within each of the one or more BTMS module(s) 202. What is meant by independently operable is that some BTMS unit(s) 204 may be operated in an active mode, where the coolant is cooled by refrigeration processes, while other BTMS unit(s) 204 may be operated passively, where coolant flows through the radiator 316 of the BTMS unit 204. As discussed herein, the BTMS units 204, within a BTMS module 202 may be arranged in parallel, such that coolant flows through all of the BTMS unit 204 within the BTMS module 202. When a BTMS unit 204 within a BTMS module 202 is not operating actively, the coolant within the BTMS unit 204 may be directed to the radiator 316, rather than the chiller 304, such as via the operation of the valve 302. The operation of individual BTMS units 204 may be controlled by the BTMS controller 128, such as based at least in part on parameters (e.g., temperature) of the elements to be cooled. For example, if a certain level of cooling is required a single BTMS unit 204 may be actively operated within a BTMS module 202 with four BTMS units 204. If a greater level is cooling is desired, then two BTMS units 204 of the same BTMS module 202 may be actively operated.

It should be noted that some of the operations of method 500 may be performed out of the order presented, with additional elements, and/or without some elements. Some of the operations of method 500 may further take place substantially concurrently and, therefore, may conclude in an order different from the order of operations shown above.

It will be appreciated that the processes of method 500 enable the deployment of the BTMS 126 as disclosed herein on the electric machine 100. This BTMS 126 can be operated in a modular way to provide an appropriate on-demand level of cooling. Thus, the cooling needs of components, such as battery pack 208, 210 of the electric machine 100 can be met in a dynamic and on-demand way. The BTMS 126, as disclosed herein, results in battery longevity due to better delivery of battery 118 thermal management needs, and therefore, reduced cost of operating the electric machine 100.

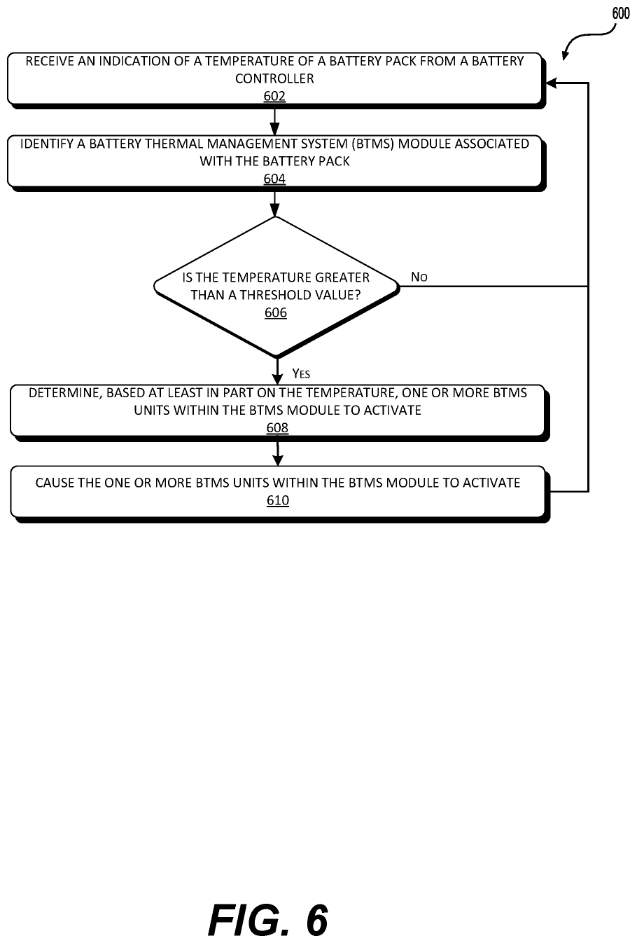

FIG. 6 is a flow diagram depicting an example method 600 for operating the battery thermal management system (BTMS) of FIG. 2, according to examples of the disclosure. The processes of method 600 may be performed by the BTMS controller 128, individually or in conjunction with one or more other components of electric machine 100. It should also be noted that the processes of method 600 may be performed when the electric machine 100 is operating (e.g., performing tasks), charging, idling, turned off, or any combination thereof.

At block 602, the BTMS controller 128 may receive an indication of a temperature of a battery pack 208, 210 from a battery controller 120. The indication of the temperature may be of any suitable kind. For example, in some cases, a temperature of a representative cell of the battery pack 208, 210 may be received. In other cases, an average, a median, a variance, a standard deviation, a minimum, a maximum, or indeed any suitable descriptive statistic of the temperature of a number of individual cells of the battery pack 208, 210 may be received by the BTMS controller 128.

At block 604, the BTMS controller 128 identifies a BTMS module 202 associated with the battery pack 208, 210 for which the indication of the temperature was received. As disclosed herein, individual battery packs 208, 210, or indeed any individual element of the electric machine 100 that is to be cooled, may have a corresponding BTMS module 202 that can be modularly operated, independent of other BTMS modules 202 of the electric machine 100. Thus, when a particular temperature level is received and/or determined by the BTMS controller 128, the BTMS controller 128 may identify the corresponding BTMS module 202 for that battery pack 208, 210.

At block 606, the BTM controller 128 may determine if the temperature indicated for the battery pack 208, 210 is greater than a corresponding threshold value. If the temperature is not greater than the corresponding threshold value, then the method 600 may return to block 602 where the BTMS controller 128 may continue to receive the indication of the temperature of the battery pack 208, 210. For example, the threshold value may be the upper range of temperatures to which the battery pack 208, 210 is to be controlled. For example, if a particular battery pack 208, 210 is to be within a range of 10° C. and 20° C., then the threshold value may be set at the upper end of that range, or 20° C. In other cases, the threshold value may be set at the midpoint of the range of allowable temperatures. In this case, with reference to the prior control range, the threshold value may be set to 15° C. In yet other cases, the threshold level may be set to a small amount under the top of the range. Again, with reference to the prior example range of temperatures, the threshold level may be set at 18° C. The range (10° C. to 20° C.) is merely an example, and the control range for the temperature of the battery packs 208, 210 may be any suitable range. In some cases, the control range for the temperature of the battery may be about 10° C. to about 40° C. In other cases, the control range for the temperatures may be in the range of about 15° C. to about 30° C. In yet other examples, the control range of temperatures may be in the range of about 10° C. to 25° C.

If at block 606, the BTMS controller 128 determines that the temperature associated with battery pack 208, 210, as received as part of the process of block 608, is greater than the corresponding threshold value, then the BTMS controller 128 may determine, based at least in part on the temperature, one or more BTMS units 204 within the BTMS module 202 to activate. The BTMS controller 128 may determine how many and/or which ones of the BTMS units 204 of the BTMS module 202 to operate actively based on a variety of parameters. For example, the total number of BTMS units 204 that are to be operated may be determined based on the how high the temperature, as received by the processes of block 602, are compared to the range of desired temperatures for the battery pack 208, 210. In some cases, the BTMS controller 128 may compare the temperature associated with the battery pack 208, 210 to multiple threshold levels to determine how many BTMS units 204 within the BTMS module 202 are to be actively operated. With respect to which of the BTMS units 204 to actively operate, the BTMS controller 128 may track the overall usage of each of the individual BTMS units 204 and actively operate in the preference of the BTMS units 204 with the lowest active operating times. In some cases, the BTMS units 204 may have a latency time after active operation when they cannot be operated efficiently, or otherwise in a desirable way. Thus, in these cases, the BTMS controller 128 may select, for operation, BTMS units 204 that have not recently (e.g., within a threshold period of time) been operated. In some cases, the determination of how many and/or which ones of the BTMS units 204 to operate in an active mode may consider ambient conditions (e.g., ambient temperature). For example, if the ambient temperature is below the desired operating range of the battery packs 208, 210 and the battery packs 208, 210 are to be cooled, then passive mode may be used, rather than active mode to cool the battery packs 208, 210.

At block 610, the BTMS controller 128 may cause the one or more BTMS units 204 within the BTMS module 202 to activate. Causing BTMS units 204 to actively operate may entail coordinating various functions of various components. For example, the BTMS module 128 may instruct the active operation of BTMS units 204 to their corresponding BTMS unit controller(s) 314. Additionally, the BTMS controller 128 may control the valve 302, in some cases, in a manner to enable the flow of coolant in to the active components of the BTMS units 204 that are to be actively operated. Still further, the BTMS controller 128 may control the pump speed of the pump(s) 216 corresponding to the BTMS module(s) 202 that are to be operated. In some cases, the pump speed, or velocity, of the pumps 216 may be determined based at least in part on the number of BTMS units 204 that are to be actively operated within the BTMS module 202 and/or the cooling needs of the corresponding battery pack 208, 210. For example, the more BTMS units 204 operating with a BTMS module 202 may result in the BTMS controller 128 causing the corresponding pump(s) 216 to operate at a greater magnitude.

It should be noted that some of the operations of method 600 may be performed out of the order presented, with additional elements, and/or without some elements. Some of the operations of method 600 may further take place substantially concurrently and, therefore, may conclude in an order different from the order of operations shown above.

Computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other cases, the databases shown can be integrated or distributed into any number of databases or other data storage devices.

### INDUSTRIAL APPLICABILITY

The present disclosure describes systems and methods for improved, modular, and on-demand cooling of components of electric machines 100, such as a battery 118, battery packs 208, 210 thereof, and/or power electronics. These electric machines 100 provide several advantages, such as reduced carbon, particulate, and/or VOC emissions, as well as high torque at low rotations per minute (RPMs). However, the electric machines 100 use batteries 118 that require temperature control. In some cases, batteries 118 used in electric machines 100 can be expensive and, therefore, it is desirable to maximize the operational lifetimes of these batteries by carefully controlling their operating conditions, including operating temperatures. Thus, the technologies disclosed herein enable the mass use of more environmentally friendly and mechanically advantageous electric machines 100, while reducing the cost of ownership and cost of use of such electric machines 100 by maximizing the operating lifetimes of the batteries 118 of the electric machines 100.

The battery thermal management system (BTMS) 126, as disclosed herein, can be used in a modular manner with a variable level of cooling intensity. Furthermore, the cooling intensity can be increased or decreased in a dynamic and on-demand way. As a result, temperatures of batteries 118 or other components of the electric machine 100 can be continuously monitored and controlled in a robust manner. Thus, the battery packs 208, 210 may be controlled for temperature within a tighter range and with no or fewer excursion outside of that tighter range than was possible with previous thermal techniques. Additionally, electric machines 100 may have a more dynamic power draw from batteries than other applications such as electric cars. The BTMS 126, as disclosed herein, enables the regulation of temperature of the battery packs 208, 210 even with the greater demands of electric machines 100 relative to other applications of electric batteries 118. As a result, the technologies and techniques discussed herein enable the electrification of a wider range of electric work and mobility solutions.

The BTMS 126 itself is an improved design over previous thermal systems because the BTMS 126 provides a variable level of cooling in a manner where subcomponents such as each of the BTMS modules 202 and/or the BTMS units 204 are not overtaxed. By operating the BTMS units 204 only when needed, the BTMS 126 disclosed herein may have a longer operating lifetime than other thermal solutions. Additionally, by controlling the operation of the BTMS units 204 in a manner where operating times are leveled, the overall BTMS 126 may have a relatively high level of operation between maintenance.

Although the systems and methods of electric machines 100 are discussed in the context of a mining trucks and other mining machinery, it should be appreciated that the systems and methods discussed herein may be applied to a wide array of machines and vehicles across a wide variety of industries, such as construction, mining, farming, transportation, military, combinations thereof, or the like. For example, the BTMS 126 and temperature control mechanism disclosed herein may be applied to a compactor in the paving industry or a harvester in the farming industry.

While aspects of the present disclosure have been particularly shown and described with reference to the examples above, it will be understood by those skilled in the art that various additional examples may be contemplated by the modification of the disclosed machines, systems and methods without departing from the spirit and scope of what is disclosed. Such examples should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. A machine, comprising:
a motor to propel the machine;
a battery configured to power the motor;
a battery controller configured to report a temperature associated with the battery; and
a battery thermal management system (BTMS) including:
a coolant line configured to circulate coolant to cool the battery;
a BTMS module having a first BTMS unit and a second BTMS unit, wherein the first BTMS unit and the second BTMS unit are independently operable, and wherein the BTMS module is configured to provide coolant cooled by the first BTMS unit and the second BTMS unit to cool the battery; and
a BTMS controller configured to receive a temperature level associated with the battery and to independently operate the first BTMS unit and the second BTMS unit.

2. The machine of claim 1, wherein the battery comprises a first battery pack and a second battery pack, wherein the BTMS module is configured to cool the first battery pack.

3. The machine of claim 2, wherein the BTMS further includes:
a second BTMS module configured to cool the second battery pack, wherein the second BTMS module includes a third BTMS unit and a fourth BTMS unit, wherein the third BTMS unit and the fourth BTMS unit are independently operable.

4. The machine of claim 3, wherein the BTMS controller is configured to independently operate the BTMS module and the second BTMS module.

5. The machine of claim 1, further comprising power electronics, wherein the BTMS is further configured to cool the power electronics.

6. The machine of claim 1, wherein the BTMS module further includes a third BTMS unit, wherein the first BTMS unit, the second BTMS unit, and the third BTMS unit are independently operable.

7. The machine of claim 1, wherein the first BTMS unit further includes:
a valve to control coolant flow into one of a chiller or a radiator.

8. The machine of claim 1, wherein the BTMS further includes:
a first pump to pump coolant through the BTMS module.

9. The machine of claim 1, wherein the BTMS further includes:
a heat exchanger to enable thermal energy from the battery to heat the coolant.

10. A method of cooling a battery, comprising:
circulating, via a coolant line and using a first pump, coolant from a first battery pack to a first battery thermal management system (BTMS) module configured to cool the coolant, wherein the first BTMS module includes a first BTMS unit and a second BTMS unit;
determining that the first BTMS unit is to actively operate to cool the first battery pack;
causing the first BTMS unit to actively operate;
circulating, via the coolant line and using a second pump, the coolant from a second battery pack to a second BTMS module configured to cool the coolant, wherein the second BTMS module includes a third BTMS unit and a fourth BTMS unit;
determining that the third BTMS unit is to actively operate to cool the first battery pack; and
causing the third BTMS unit to actively operate.

11. The method of claim 10, further comprising:
controlling a first valve to allow the coolant to enter a chiller associated with the first BTMS unit.

12. The method of claim 10, wherein the first pump and the second pump draws the coolant from a coolant tank.

13. The method of claim 10, wherein determining that the first BTMS unit is to operate to cool the first battery pack further comprises:
receiving, by a BTMS controller, a temperature level associated with the first battery pack;
determining that the temperature level of the first battery pack is greater than a threshold level; and
determining, by the BTMS controller and based at least in part on the temperature level being greater than the threshold level, that at least one of the first BTMS unit or the second BTMS unit is to be actively operated.

14. The method of claim 10, further comprising:
circulating coolant through a heat exchanger associated with the first battery pack.

15. The method of claim 10, further comprising:
receiving, by a BTMS controller, a temperature level associated with the second battery pack;
determining that the temperature level of the second battery pack is less than a threshold level;
determining, by the BTMS controller and based at least in part on the temperature level being less than the threshold level, that the third BTMS unit is to be operated passively; and
causing the third BTMS unit to be operated passively, wherein the coolant is flowed through a radiator associated with the third BTMS unit.

16. A battery thermal management system (BTMS), comprising:
a first BTMS module configured to cool a first battery pack, the first BTMS module having a first BTMS unit and a second BTMS unit, wherein the first BTMS unit and the second BTMS unit are independently operable, and wherein each of the first BTMS unit and the second BTMS unit are configured to actively or passively cool coolant;
a second BTMS module configured to cool a second battery pack, the second BTMS module having a third BTMS unit and a fourth BTMS unit, wherein the third BTMS unit and the fourth BTMS unit are independently operable, and wherein the third BTMS unit and the fourth BTMS unit are configured to actively or passively cool the coolant; and
a BTMS controller configured to receive a temperature level associated with at least one of the first battery pack or the second battery pack and cause at least one of the first BTMS module or the second BTMS module to operate.

17. The BTMS of claim 16, further comprising:
a first pump to pump the coolant through the first BTMS module; and
a second pump to pump the coolant through the second BTMS module.

18. The BTMS of claim 16, further comprising:
a first valve to control coolant flow within the first BTMS unit; and
a second valve to control coolant flow within the second BTMS unit.

19. The BTMS of claim 16, further comprising:
a first heat exchanger to enable thermal energy from the first battery pack to heat the coolant inside the first heat exchanger; and
a second heat exchanger to enable thermal energy from the second battery pack to heat the coolant inside the second heat exchanger.

20. The BTMS of claim 16, wherein the first BTMS module further includes a fifth BTMS unit, wherein the first BTMS unit, the second BTMS unit, and the fifth BTMS unit are independently operable.
